(19) United States
(12) Patent Application Publication
(10) Pub. No.: US 2005/0090267 A1
(43) Pub. Date: Apr. 28, 2005

(54) Method and apparatus for enabling a device by proximity

(76) Inventor: Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/692,638

(22) Filed: Oct. 24, 2003

(51) Int. Cl. H04Q 7/20

(52) U.S. Cl. 455/456.4

(57) ABSTRACT

A method (200) and an apparatus (600) for a wireless portable communication device (102) for enabling and disabling the wireless portable communication device (102) are provided. The wireless portable communication device (102) monitors for a proximity signal (106) including a first authorization code transmitted from a controller unit (104), and determines whether the first authorization code is valid upon receiving the proximity signal (106). Upon determining the first authorization code is valid, the wireless portable communication device (102) is enabled for normal operation. Otherwise, the wireless portable communication device (102) monitors for a second authorization code, and determines whether the second authorization code is valid upon receipt. Upon determining the second authorization code is valid, the wireless portable communication device (102) is enabled for normal operation. Otherwise, the wireless portable communication device (102) is disabled.

### FIELD OF THE INVENTION

The present invention generally relates to sensing based upon the proximity of devices, and more specifically to enabling and disabling devices based upon the proximity to each other.

### BACKGROUND OF THE INVENTION

As wireless portable communication devices, such as cellular telephones and personal digital assistants (“PDAs”) including PDAs equipped with cellular telephones, are made smaller and lighter, they have also become easy to be lost, misplaced, or stolen. These devices that have been stolen or recovered by those who then decide to misuse the devices, services and information associated with these devices can be abused or inappropriately accessed. For example, before a rightful owner realizes that his PDA-cellular telephone has been stolen and notifies his service provider to suspend the service, a thief can make unauthorized use of the PDA-cellular telephone and is also able to access personal information, such as a stored phonebook and a calendar. Even if the service is terminated, the thief still may be able to access the stored information.

### BRIEF DESCRIPTION OF THE DRAWINGS

FIG. 1 is an exemplary block diagram of an environment where the present invention may be practiced;

FIG. 2 is an exemplary flowchart of a first embodiment for enabling a wireless portable communication device based on proximity to a controller unit in accordance with the present invention;

FIG. 3 is an exemplary flowchart further illustrating one of the blocks of FIG. 2 for providing a predetermined monitoring time within which the proximity signal can be received;

FIG. 4 is an exemplary flowchart further illustrating one of the blocks of FIG. 2 for providing a predetermined time period within which the wireless portable communication device is allowed to operate normally;

FIG. 5 is an exemplary flowchart further illustrating one of the blocks of FIG. 2 for providing a time period within which the wireless portable communication device is allowed to operate normally based upon a predetermined time period and call termination; and

FIG. 6 is an exemplary block diagram of a second embodiment of an apparatus for a wireless portable communication device in accordance with the present invention.

### DETAILED DESCRIPTION OF THE PREFERRED EMBODIMENTS

The present invention relates to a method and an apparatus for enabling and disabling a wireless portable communication device based upon its proximity to a controller unit. A first preferred embodiment in accordance with the present invention provides a method in a wireless portable communication device, such as a cellular telephone, for enabling and disabling the wireless communication device based upon its proximity to a controller unit. The controller unit transmits a proximity signal including an authorization code that enables normal operation of the wireless portable communication device. The proximity signal is characterized by its signal strength such that its range is intentionally limited, and may be transmitted in various ways. For example, the transmission of the proximity signal may be characterized by a specific signal level assigned to the proximity signal, or may be transmitted using a separate transmitter suitable for a Bluetooth™ network, a wireless local area network (“WLAN”), or an inductive coupling network. Upon successful reception of the proximity signal and the authorization code, the wireless portable communication device is enabled. Upon unsuccessful reception of the proximity signal or the authorization code, the wireless portable communication device is provided with a re-try time period within which another reception of the proximity signal and the authorization code is attempted. Upon failing twice to receive the proximity signal and the authorization code, the wireless portable communication device is disabled. A simple and easy-to-carry device, such as a watch or a ring, may function as the controller unit having necessary capability included in the device. The controller unit may also be another wireless portable communication device. A second preferred embodiment of the present invention provides an apparatus, preferably a wireless portable communication device such as a cellular telephone, configured to be enabled or disabled based upon a proximity signal including an authorization code transmitted from a controller unit.

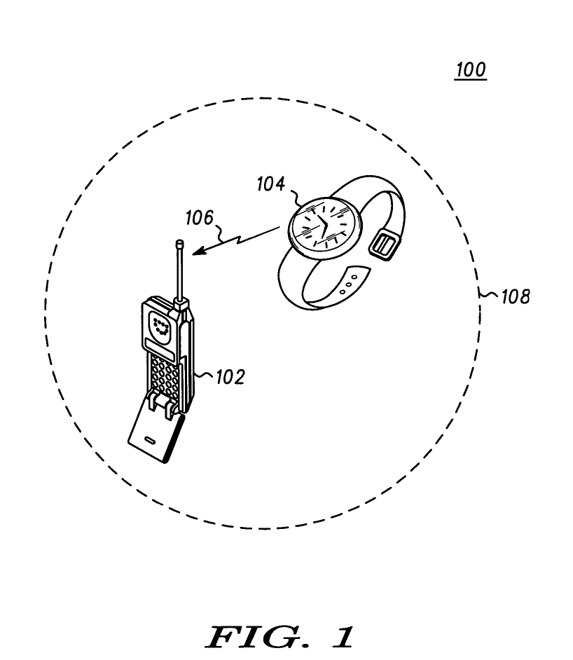

FIG. 1 is an exemplary block diagram 100 of an environment where the present invention may be practiced. In this environment, there are a wireless portable communication device 102 and a controller unit 104. The controller unit 104 transmits a proximity signal 106. The range of the proximity signal 106 can be affected or controlled by the strength of the transmitted signal. One example of an area, or a distance, that is considered to be proximate to the wireless portable communication device 102 is shown as a dotted circle 108. The dotted circle 108 indicates that the wireless portable communication device 102 is able to adequately receive the proximity signal 106 transmitted from the controller unit 104 within the area marked by the dotted circle 108.

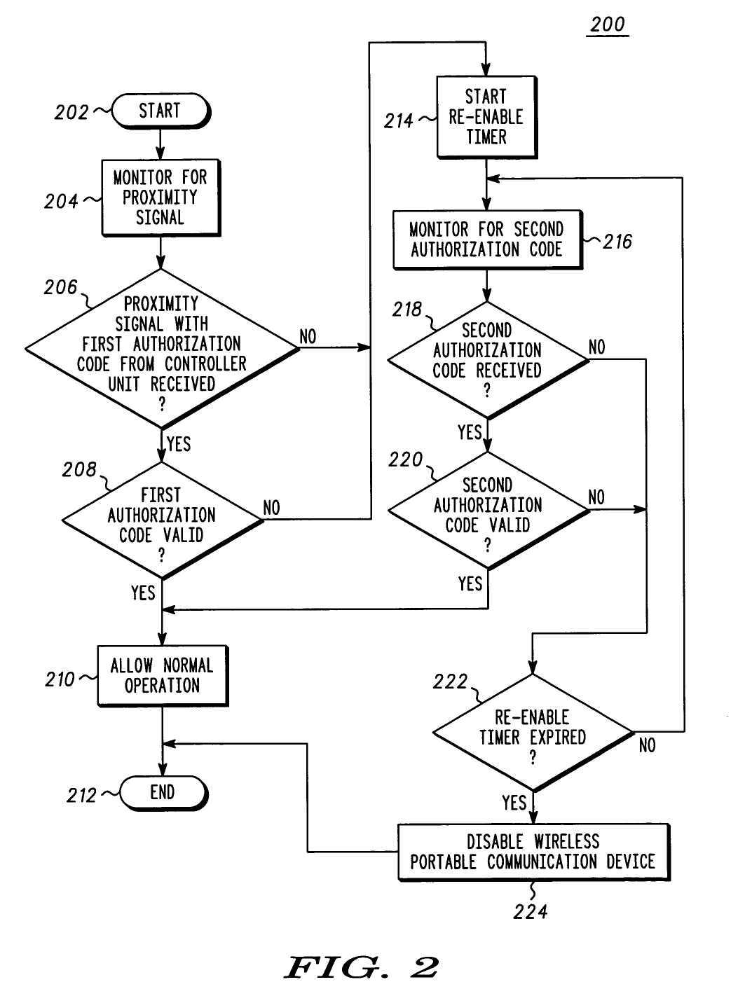

FIG. 2 illustrates an exemplary flowchart 200 of a process of a first embodiment according to the present invention describing a method for enabling or disabling the wireless portable communication device 102 based upon the proximity signal 106 transmitted from the controller unit 104 shown in FIG. 1. The process begins in block 202. The wireless portable communication device 102 may initiate the process by requesting the controller unit 104 to transmit an authorization code, which allows normal operation of the wireless portable communication device 102, to the wireless communication device 102. The request may be a result of a user initiating a call or an incoming call to the wireless portable communication device 102. Alternatively, the controller unit 104 may continuously transmit the authorization code.

In block 204, the wireless portable communication device 102 begins to monitor for the proximity signal 106 transmitted from the controller unit 104. The wireless portable communication device 102, for example, may begin monitoring when it is powered on. The proximity signal 106 includes a first authorization code, which allows normal operation of the wireless portable communication device 102 if it is validated. In block 206, whether the proximity signal 106 with the first authorization code has been received is checked. If it is determined that the proximity signal with the first authorization code has been received in block 206, then whether the first authorization code is valid is determined in block 208. If the first authorization code is determined to be valid in block 208, then the wireless portable communication device 102 is allowed to operate normally in block 210, and the process terminates in block 212.

If it is determined that either the proximity signal with the first authorization code has not been received in block 206, or the first authorization code is not valid in block 208, then in block 214, a timer begins to count down a predetermined re-enabling time period within which the wireless portable communication device 102 attempts to receive an authorization to operate normally. The predetermined re-enabling time period is provided to prevent an accidental or unintentional disabling of the wireless portable communication device 102. For example, the wireless portable communication device 102 or the controller unit 104 may experience fading such that the proximity signal is lost. In block 216, the wireless portable communication device 102 begins to monitor for a second authorization code, and whether the second authorization code is received is checked in block 218. The wireless portable communication device 102 may receive the second authorization code by receiving another proximity signal, which includes the second authorization code, transmitted from the controller unit 104, or may receive the second authorization code directly through a user interface of the wireless portable communication device 102. If it is determined that the second authorization code has been received in block 218, then whether the second authorization code is valid is determined in block 220. If the second authorization code is determined to be valid in block 220, then the wireless portable communication device 102 is allowed to operate normally in block 210, and the process terminates in block 212. Examples of the first and second authorization codes include a password, a personal identification number, and biometric information such as a finger print. The first authorization code may be the same as the second authorization code.

If it is determined that either the second authorization code has not been received in block 218, or the second authorization code is not valid in block 220, then in block 222, whether the predetermined re-enabling time period has expired is checked. If the predetermined re-enabling time period has not expired, then the process repeats from block 216. However, if the predetermined re-enabling time has expired, then the wireless portable communication device 102 is disabled in block 224, and the process terminates in block 212. The disabling of the wireless portable communication device 102 may be accomplished by only disabling a specific functionality of the wireless portable communication device 102.

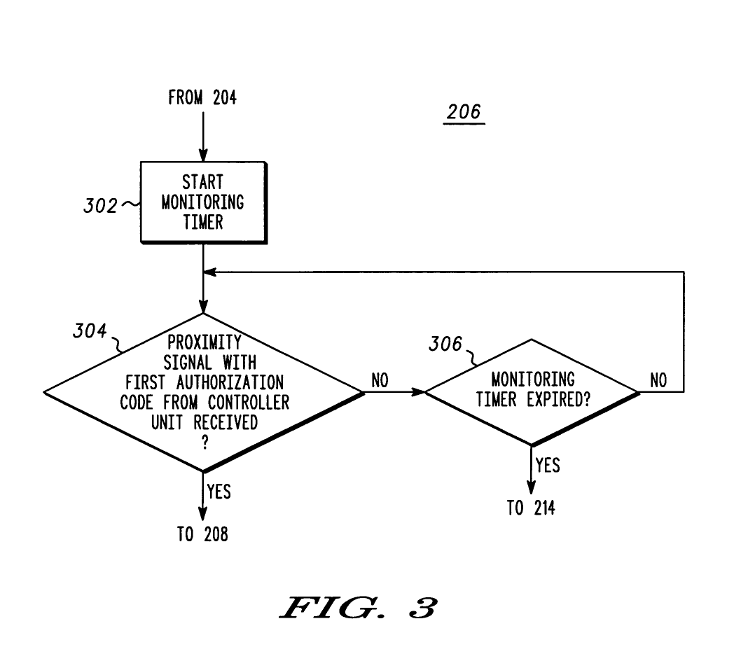

FIG. 3 is an exemplary flowchart further illustrating block 206 of FIG. 2 for providing a predetermined monitoring time within which the proximity signal can be received. A time period, within which the proximity signal must be received and the first authorization code must be validated, may be limited to avoid the wireless portable communication device 102 from accepting the proximity signal indefinitely. For example, if the proximity signal is not received over an extended period of time, such as one day, of powering on the wireless portable communication device 102, then it may be assumed that the wireless portable communication device 102 is lost or misplaced, and may be advantageous to disable it. After the wireless portable communication device 102 begins to monitor for the proximity signal 106 in block 204, the timer begins to count down a predetermined monitoring time period within which the wireless portable communication device 102 attempts to receive the proximity signal with the first authorization code in block 302. In block 304, whether the proximity signal 106 with the first authorization code has been received is checked. If it is determined that the proximity signal with the first authorization code has been received in block 304, then the process advances to block 208. If the proximity signal with the first authorization code has not been received in block 304, then whether the predetermined monitoring time period has expired is checked in block 306. If the predetermined monitoring time period has not expired, then the process repeats from block 304. If the predetermined monitoring time period has expired, then the process advances to block 214.

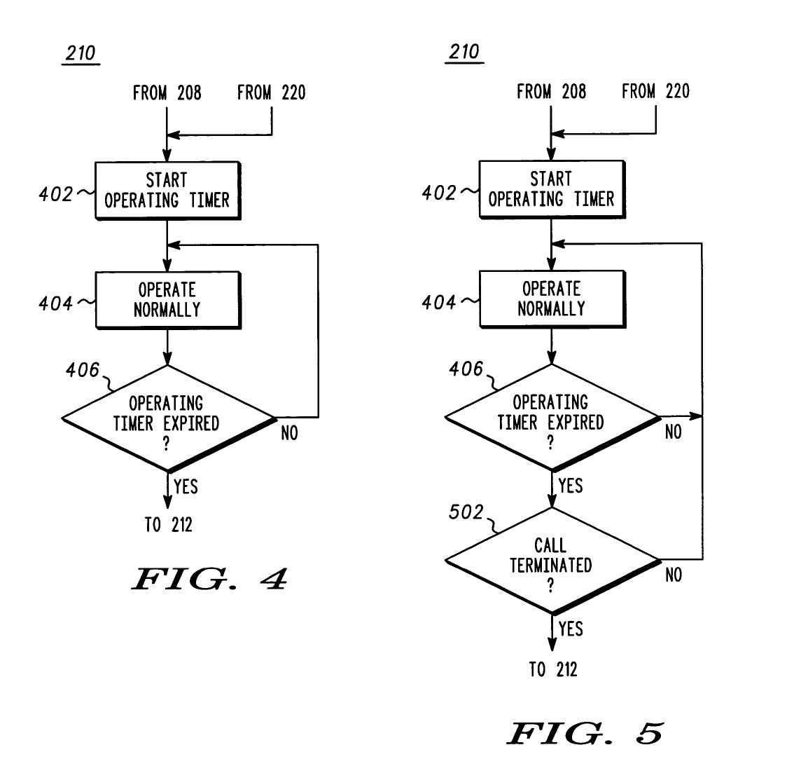

FIG. 4 is an exemplary flowchart further illustrating block 210 of FIG. 2 for providing a predetermined time period within which the wireless portable communication device 102 is allowed to operate normally. Once the wireless portable communication device 102 is allowed to operate normally, a time limit may be imposed on how long the wireless portable communication device 102 is allowed to operate to avoid unauthorized use at a later time. After the first authorization code is determined to be valid in block 208 or after the second authorization code is determined to be valid in block 220, the timer begins to count down a predetermined operating time period within which the wireless portable communication device 102 is allowed to operate normally in block 402, and the wireless portable communication device 102 begins to operate normally in block 404. In block 406, whether the predetermined operating time period has expired is checked. If the predetermined operating time period has not expired, then the wireless portable communication device 102 is allowed to continue operating normally. If the predetermined operating time period has expired, then the process advances to block 212 where the process is terminated.

Alternatively, the predetermined operating time period may be limited by the length of a call being made as shown in FIG. 5. After the predetermined operating time period has expired, whether the call which initiated the process is still active is checked in block 502. If the call is still active, the wireless portable communication device 102 is allowed to continue operating normally. If the call is no longer active, the process advances to block 212 where the process is terminated. The predetermined operating time period may alternatively be terminated upon terminating the call.

The wireless portable communication device 102 may provide a notification upon determining that the first authorization code is not valid, or the second authorization code is not valid. The notification may be provided by transmitting a notification signal to the controller unit, by displaying the notification, or by audibly playing the notification.

The wireless portable communication device 102 may determine whether the first authorization code is valid by comparing the first authorization code to an authorization code stored in the wireless portable communication device 102. The authorization code, which is compared to the first authorization code may be entered and stored into the wireless portable communication device 102 in various ways. For example, the user may initially enter the authorization code directly into the wireless portable communication device 102 before the proximity based authorization process begins by using the user interface of the wireless portable communication device 102 and store the authorization code in the wireless portable communication device 102. The authorization code may also be entered directly into the controller unit 104 as the first authorization code using a user interface of the controller unit 104. Instead of directly entering the authorization code into the controller unit 104, the wireless portable communication device 102 may transmit the entered authorization code to the controller unit 104, and the controller unit 104 then stores the transmitted authorization code, which it has received, as the first authorization code in the controller unit 104.

The process of storing the authorization code may also begin from the controller unit 104. The user may initially enter the authorization code directly into the controller unit 104 as the first authorization code before the proximity based authorization process begins by using the user interface of the controller unit 104 and store the authorization code in the controller unit 104. Then the controller unit 104 transmits the entered authorization code to the wireless portable communication device 102, and the wireless portable communication device 102 stores the transmitted authorization code, which it has received, as the first authorization code in the wireless portable communication device 102.

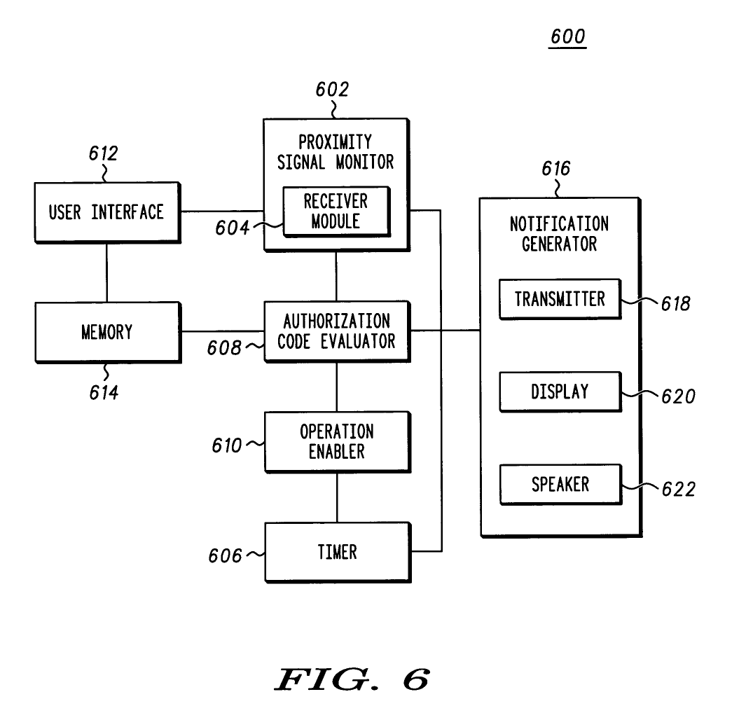

FIG. 6 is an exemplary block diagram 600 of a second embodiment in accordance with the present invention describing an apparatus for the wireless portable communication device 102. The wireless portable communication device 102 is configured to be enabled or disabled based upon proximity to the controller unit 104, and comprises the following components. A proximity signal monitor 602, which includes a receiver module 604, is configured to monitor and to receive the proximity signal 106, which includes the first authorization code and is transmitted from the controller unit 104, within a predetermined monitoring time period. The receiver module 604 may contain a single receiver configured to receive both the proximity signal 106 and radio frequency communication signals during normal operation. Alternatively, the receiver module 604 may contain separate receivers with one receiver for receiving the proximity signal 106 and another receiver for receiving radio frequency communication signals during normal operation. A timer 606 is coupled to the proximity signal monitor 602, and is configured to track the predetermined monitoring time period. An authorization code evaluator 608 is also coupled to the proximity signal monitor 602, and is configured to determine whether the first authorization code is valid when the proximity signal monitor 602 receives the proximity signal 106. An operation enabler 610 is coupled to the authorization code evaluator 608 and to the timer 606, and is configured to enable normal operation of the wireless portable communication device 102 if the authorization code evaluator 608 determines the first authentication code is valid. If the authorization code evaluator 608 determines that the first authorization code is not valid, then the proximity signal monitor 602 begins to monitor for a second authorization code during a predetermined re-enabling time period, which is also tracked by the timer 606. Then, the authorization code evaluator 608 determines whether the second authorization code is valid when the proximity signal monitor 602 receives the second authorization code during the predetermined re-enabling time period. The second authorization code may be received as a part of a second proximity signal transmitted by the controller unit 104. If the authorization code evaluator 608 determines that the second authorization code is valid, then the operation enabler 610 enables the normal operation of the wireless portable communication 102. Otherwise, the operation enabler 610 disables the wireless portable communication device 102.

The authorization code evaluator 608 may determine that the first authorization code is not valid if the proximity signal monitor 602 fails to receive the proximity signal 106 within the predetermined monitoring time period and that the second authorization code is not valid if the second authorization code is not received within the predetermined re-enabling time period. The second authorization code may be the same as the first authorization code.

The wireless portable communication device 102 further comprises a user interface 612, which is coupled to the proximity signal monitor 602 and is configured to accept a user input code, and memory 614, which is coupled to the user interface 612 and to the authorization code evaluator 608. The user can enter information such as the authorization code using the user interface 612, and store it in the memory 614. The authorization code evaluator 608 can then determine whether the first authorization code is valid by comparing the first authorization code to the stored user input code in the memory 614, and whether the second authorization code is valid by comparing the second authorization code to the user input code stored in the memory 614. The user interface 612 may allow the user to enter the first and/or the second authorization code directly into the wireless portable communication device 102.

The wireless portable communication device 102 further comprises a notification generator 616, which is coupled to the authorization code evaluator 608, and is configured to provide a notification upon determining that the first authorization code or the second authorization is not valid. The notification generator 616 comprises at least one of the following modules to provide a notification. A transmitter 618 is coupled to the authorization code evaluator 608, and is configured to transmit the notification signal to the controller unit 104 when the authorization code evaluator 608 determines that the first authorization code or the second authorization is not valid. The transmitter 618 is also used for transmitting radio frequency communication signals during normal operation. A display 620 is coupled to the authorization code evaluator 608, and is configured to display the notification when the authorization code evaluator 608 determines that the first authorization code or the second authorization is not valid. A speaker 622 is coupled to the authorization code evaluator 608, and is configured to audibly play the notification when the authorization code evaluator 608 determines that the first authorization code or the second authorization is not valid.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method in a wireless portable communication device for enabling the wireless portable communication device, the method comprising:
monitoring for a proximity signal including a first authorization code transmitted from a controller unit;
determining whether the first authorization code is valid upon receiving the proximity signal;
if the first authorization code is not valid;
monitoring for a second authorization code during a predetermined re-enabling time period;
determining whether the second authorization code is valid upon receiving the second authorization code during the predetermined re-enabling time period; and
enabling normal operation of the wireless portable communication device upon determining that a valid authorization code has been received.

2. The method of claim 1, wherein, after monitoring for the proximity signal, determining a valid authorization code has not been timely received if the proximity signal is not received within a predetermined monitoring time period.

3. The method of claim 1, further comprising:
disabling the wireless portable communication device upon failing to receive the second authorization code during the predetermined re-enabling time period.

4. The method of claim 1, wherein enabling the normal operation of the wireless portable communication device by enabling the normal operation for a predetermined operating time period.

5. The method of claim 1, wherein disabling the wireless portable communication device upon determining the second authorization code is not valid by disabling a specific functionality of the wireless portable communication device.

6. The method of claim 1, wherein the first and second authorization codes comprise at least one of password, personal identification number, and biometric information.

7. The method of claim 1, further comprising providing a notification upon determining at least one of:
the first authorization code is not valid; and
the second authorization code is not valid.

8. The method of claim 7, wherein providing the notification by at least one of:
transmitting a notification signal to the controller unit;
displaying the notification; and
audibly playing the notification.

9. The method of claim 1, wherein the second authorization code is the same as the first authorization code.

10. The method of claim 1, wherein receiving the second authorization code during the predetermined re-enabling time period by at least one of:
receiving the second authorization code directly from a user interface of the wireless portable communication device; and
receiving a second proximity signal including the second authorization code transmitted from the controller unit.

11. The method of claim 1, wherein the controller unit is a second wireless portable communication device.

12. The method of claim 1, wherein determining whether the first authorization code is valid by comparing the first authorization code to a stored authorization code.

13. The method of claim 12, prior to monitoring for the proximity signal, further comprising:
entering the stored authorization code directly into the wireless portable communication device using a user interface of the wireless portable communication device; and
entering the stored authorization code directly into the controller unit as the first authorization code using a user interface of the controller unit.

14. The method of claim 12, prior to monitoring for the proximity signal, further comprising:
entering the stored authorization code directly into the wireless portable communication device using a user interface of the wireless portable communication device;
transmitting the stored authorization code to the controller unit; and
entering the transmitted stored authorization code into the controller unit as the first authorization code.

15. The method of claim 12, prior to monitoring for the proximity signal, further comprising:
entering the stored authorization code directly into the controller unit as the first authorization code using a user interface of the controller unit;
transmitting the stored authorization code to the wireless portable communication device from the controller unit; and
entering the transmitted stored authorization code into the wireless portable communication device as the stored authorization code.

16. A wireless portable communication device configured to be enabled and disabled based upon proximity to a controller unit, the wireless portable communication device comprising:
a proximity signal monitor, the proximity signal monitor configured to monitor and to receive a proximity signal within a predetermined monitoring time period, the proximity signal including a first authorization code transmitted from the controller unit;
an authorization code evaluator coupled to the proximity signal monitor, the authorization code evaluator configured to determine whether the first authorization code is valid when the proximity signal monitor receives the proximity signal;
an operation enabler coupled to the authorization code evaluator, the operation enabler configured to enable normal operation of the wireless portable communication device if the authorization code evaluator determines the first authentication code is valid, and
wherein if the first authorization code is not valid,
the proximity signal monitor monitors for a second authorization code during a predetermined re-enabling time period, the predetermined re-enabling time period tracked by the timer,
the authorization code evaluator determines whether the second authorization code is valid when the proximity signal monitor receives the second authorization code during the predetermined re-enabling time period, and
if the second authorization code is valid, the operation enabler enables the normal operation of the wireless portable communication,
otherwise, the operation enabler disables the wireless portable communication device.

17. The wireless portable communication device of claim 16, further comprising:
a timer coupled to the proximity signal monitor and to the operation enabler, the timer configured to track the predetermined monitoring time period and the predetermined re-enabling period.

18. The wireless portable communication device of claim 16, wherein the authorization code evaluator determines:
the first authorization code is not valid if the proximity signal monitor fails to receive the proximity signal within the predetermined monitoring time period; and
the second authorization code is not valid if the second authorization code is not received within the predetermined re-enabling time period.

19. The wireless portable communication device of claim 18, wherein the second authorization code is the same as the first authorization code.

20. The wireless portable communication device of claim 18, further comprising:
a user interface coupled to the proximity signal monitor, the user interface configured to accept a user input code; and
memory coupled to the user interface and to the authorization code evaluator, the memory configured to store the user input code,
wherein the authorization code evaluator determines at least one of:
whether the first authorization code is valid by comparing the first authorization code to the stored user input code in the memory, and
whether the second authorization code is valid by comparing the second authorization code to the user input code stored in the memory.

21. The wireless portable communication device of claim 20, wherein the proximity signal monitor receives the second authorization code by at least one of:
receiving the second authorization code entered in the user interface during the pre-determined re-enabling period; and
receiving a second proximity signal including the second authorization code.

22. The wireless portable communication device of claim 18, further comprising a notification generator coupled to the authorization code evaluator, the notification generator configured to provide a notification upon determining at least one of the first authorization code is not valid and the second authorization code is not valid, the notification generator comprising at least one of:
a transmitter coupled to the authorization code evaluator, the transmitter configured to transmit a notification signal to the controller unit;
a display coupled to the authorization code evaluator, the display configured to display the notification; and
a speaker coupled to the authorization code evaluator, the speaker configured to audibly play the notification.
